(19) United States
(12) Patent Application Publication
(10) Pub. No.: US 2023/0108541 A1
(43) Pub. Date: Apr. 6, 2023

(54) DISPENSING PLANT WITH AUTO-CALIBRATION AND AUTO-CALIBRATION METHOD THEREOF

(71) Applicant: CELLI S.P.A., SAN GIOVANNI IN MARIGNANO (IT)

(72) Inventors: Daniele CECCARINI, SAN GIOVANNI IN MARIGNANO (IT); Andrea Maria PALOPOLI, SAN GIOVANNI IN MARIGNANO (IT); Fabrizio FARACI, SAN GIOVANNI IN MARIGNANO (IT)

(73) Assignee: CELLI S.P.A., SAN GIOVANNI IN MARIGNANO (IT)

(21) Appl. No.: 17/955,779

(22) Filed: Sep. 29, 2022

(30) Foreign Application Priority Data
Oct. 1, 2021 (IT) 102021000025205

(51) Int. Cl. B67D 1/00; B67D 1/08

(52) U.S. Cl. CPC B67D 1/0034; B67D 1/0888

(57) ABSTRACT

A plant for dispensing a beverage of one or more fluids ingredients into a container, including one or more dispensing lines to dispense the fluid ingredients, a nozzle, fluid-dynamically connected to the dispensing lines for dispensing the beverage into the container, a control unit to associate values with the flow rate of fluid in the dispensing lines, the plant further including at least one calibration unit connected to the control unit for measuring a value associated with the quantity of fluids dispensed into the container and adjust the values associated with the flow rate of the fluid in each of the dispensing lines, so the difference between the measurement of the values associated with the quantity of fluids delivered in the container and the quantity of fluid associated with the flow rate of fluid in the dispensing lines is less than a threshold or in a confidence interval.

The present invention relates to an auto-calibration dispensing plant and auto-calibration method thereof.

### FIELD OF THE INVENTION

More in specifically, the invention relates to a plant of the aforementioned type, designed and realized in particular for calibrating the dispensing of a beverage in a glass or container in general, but which can be used for any circumstance in which it is necessary to perform an automatic calibration of the dispensing of a liquid.

In the following the description will be addressed to beverage dispensing plants, but it is clear that the same should not be considered limited to this specific use.

### PRIOR ART

As is well known, there are currently various beverage dispensing systems also known by the term “post-mix”. Such dispensing systems or systems for dispensing a beverage provide for its composition at the moment of dispensing. To obtain the required drink, therefore, the ingredients of these drinks must be mixed with a precise mixing ratio, regulated by means of special flow valves.

To date, the mixing ratio is monitored by flow sensors. These sensors are generally based on encoders or similar counter devices, which measure a number of pulses in the unit of time, from which it is possible to trace the volume delivered through the delivery time.

Flow sensors generally need to be calibrated. During the calibration step, the actual flow rate associated with a specific number of pulses in the unit of time measured by the flow sensor is measured; the measurement is repeated for multiple pulse values in the unit of time and then a fit to associate the equation of a straight line with the data is obtained.

The procedure is repeated for each ingredient available in the dispensing system, in order to obtain a calibration line for each ingredient.

These data (or curves) relating to the behavior of each flow sensor with respect to the different ingredients, for which it can be used, are stored in a control unit of the dispensing system, so that it is possible to program said control unit, so that when it is connected to the different dispensing lines of the different ingredients to make the required beverages, can accurately detect the actual flow rates of each line and accurately estimate the quantities dispensed through each line, allowing the optimal dispensing of the beverage, according to the desired recipe for each of them.

However, it is known that the actual quantity delivered of the individual components also depends on other contingent factors, such as for example the temperature and pressure of the components themselves. Because of this, it is necessary to perform the calibration of the delivery systems both before putting a plant into operation, and at periodic intervals.

To date, during these periodic calibrations, a specialized operator carries out measurements of the quantities of ingredients dispensed and consequent adjustments of the intercept of the equation of the fit line, in order to restore the conditions for the correct dispensing of each individual ingredient.

A first disadvantage of these periodic calibrations is the high time required with the consequent associated costs.

A further disadvantage of this solution is the need to employ a specialized operator in carrying out the appropriate measurements and adjustments.

### OBJECT OF THE INVENTION

Therefore, the object of the present invention is to provide a dispensing system whose calibration is automated.

A further object of the present invention is to provide a dispensing system whose calibration is rapid.

Another object of the present invention is to provide a method for performing such calibration.

### Object of the Invention

It is, therefore, specific object of the present invention a plant for dispensing a beverage composed of one or more fluids ingredients into a container, comprising one or more dispensing lines to dispense said one or more fluid ingredients, a nozzle, fluid-dynamically connected to said one or more dispensing lines, for dispensing said beverage into said container, a control unit, configured to associate values with the flow rate of fluid in said one or more dispensing lines, wherein said plant comprises at least one calibration unit, operatively connected to said control unit, for measuring a value associated with the quantity of fluids dispensed into said container, and said control unit is configured to adjust the values associated with the flow rate of the fluid in each of said one or more dispensing lines, so that the difference between the measurement of said values associated with the quantity of fluids delivered in said container and the quantity of fluid associated with said flow rate of fluid in said one or more dispensing lines, is less than a predefined calibration threshold or in a predefined calibration confidence interval.

Further according to the invention, one or more predetermined flow rate values are stored in said control unit, each associated with a line of said one or more dispensing lines and said control unit is configured to estimate the quantity of fluid delivered starting from the delivery time and from said one or more predetermined flow rate values.

Always according to the invention, said plant comprises one or more flow rate sensors, wherein each flow rate sensor is arranged on a respective dispensing line, to measure the flow rate of delivered fluid, said control unit is connected to said flow rate sensors and is configured to receive the measurement of the flow rate detected by each flow rate sensor, and to adjust the value associated with the detection of each of said flow rate sensors, so that the difference between the measurement of said value associated with the quantity of fluids delivered in said container and the detection of the quantity of fluid dispensed through one or more dispensing lines associated with the respective flow rate sensors, is less than said predefined calibration threshold or in a predefined calibration confidence interval.

Preferably according to the invention, said plant comprises one or more adjusting valves, each arranged on a respective dispensing line, in series with a respective flow rate sensor, for adjusting the quantity of fluid ingredient dispensed through said respective dispensing line, and said control unit is connected to said adjusting valves and configured to control each of said adjusting valves.

Still according to the invention, said calibration unit comprises an optical sensor, arranged in proximity to said nozzle and operatively connected to said control unit, capable of detecting the filling level of said container.

Further according to the invention, said calibration unit comprises a weight sensor, arranged below said nozzle and operatively connected to said control unit, capable of detecting the mass of said container.

Always according to the invention, said calibration unit comprises a detection container, operatively connected to said control unit and intended to be arranged below said nozzle when the calibration is required, and said detection container comprises two internal partitions, each designed to contain one or more fluids delivered from said nozzle.

Preferably according to the invention, said plant comprises one or more tanks, in fluid dynamic communication with said one or more dispensing lines in which one or more fluids to be dispensed contained.

Still according to the invention, said plant comprises a gateway, connected to said control unit, and a cloud unit, connected to said gateway and connectable to mobile devices such as smartphones, tablets, and computers, to control and start the calibration of said plant, wherein the calibrations of said plant can be stored in said cloud unit.

It is also object of the present invention a calibration method of a plant according to any one of the preceding claims, wherein conversion parameters are stored in said control unit to associate said values to the fluid flow rate, comprising the following steps: activating the delivery of a fluid from a first dispensing line into said container through said nozzle; receiving a value associated with the quantity of fluid delivered into said container; converting said value received in said step into a quantity value of said fluid by means of said conversion parameters; comparing said value converted in said conversion step with a confidence interval or with a predefined threshold, such that if said value lies outside said confidence interval or it is greater than said predefined threshold, adjusting said parameters for converting said received value into a quantity value of said fluid; else, if said value lies within said confidence interval or it is greater than said predefined threshold, terminating the calibration of said first dispensing line; repeating the previous steps for said second dispensing line and for each of said dispensing lines.

Further according to the invention, said comparison step, if one of said converted values lies outside a control interval, greater than said confidence interval of calibration, or is greater than a predefined control threshold greater than said calibration threshold, an alarm is generated.

It is additionally object of the present invention a computer program comprising instructions which, when the program is executed by a computer, causes the computer to execute the steps of said method.

It finally object of the present invention a storage medium readable by a computer comprising instructions which, when executed by a computer, causes the computer to execute the steps of said method.

### BRIEF DESCRIPTION OF THE FIGURES

The present invention will be now described, for illustrative but not imitative purposes, according to its preferred embodiments, with particular reference to the figures of the enclosed drawings, wherein:

FIG. 1 shows a dispensing system, object of the present invention, in a first embodiment;

FIG. 2 shows the dispensing system, in a second embodiment;

FIG. 3 shows the dispensing system, in a third embodiment;

FIG. 4 shows the dispensing system, in a fourth embodiment;

FIG. 5 shows a flow diagram of the calibration method, object of the present invention; and

FIG. 6 shows a calibration graph of the dispensing system object of the present invention.

### DETAILED DESCRIPTION

In the various figures similar parts will be indicated with the same numerical references.

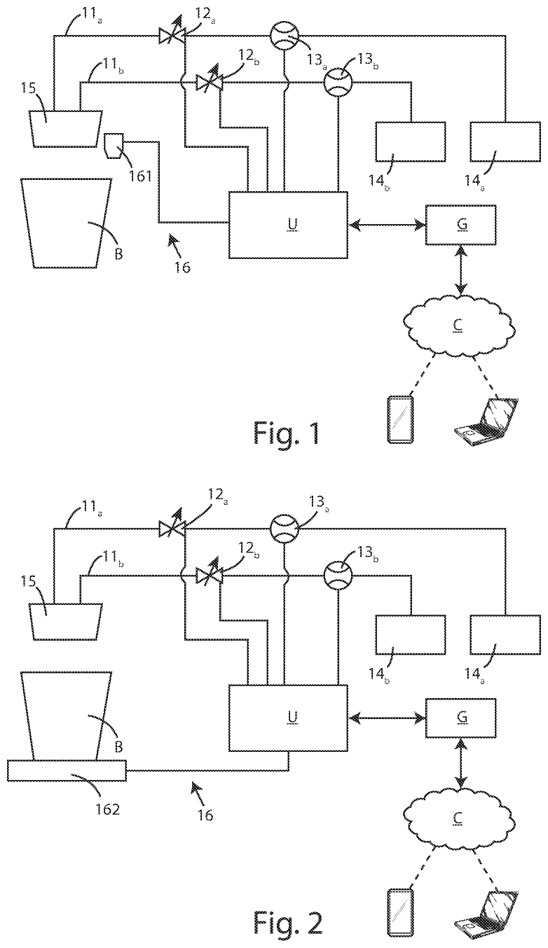

With reference to FIG. 1, it is possible to observe a first embodiment of a system 1 for dispensing one or more fluids, comprising one or more dispensing lines 11_{a, b}, one or more control valves 12_{a, b}, a control unit U, one or more flow rate sensors 13_{a, b}, one or more tanks 14_{a, b}, a dispensing nozzle 15, and a calibration unit 16.

Each of said one or more tanks 14_{a, b} can contain a fluid, such as for example water, a syrup, or water combined with carbon dioxide, also known in the sector as soda.

The dispensing lines 11_{a, b} put said one or more tanks 14_{a, b} with said dispensing nozzle 15.

The dispensing nozzle 15 is capable of delivering a fluid or a mixture of fluids, which can be collected in a container B, such as for example a glass, placed below said dispensing nozzle 15.

Each adjusting valve 12_{a, b} is arranged on a respective dispensing line 11_{a, b}, to regulate the flow rate of fluid between the respective tank 14_{a, b} and the nozzle 15, and it is operatively connected to the control unit U.

Each flow rate sensor 13_{a, b}, is arranged on a respective dispensing line 11_{a, b}, in series to an adjusting valve 12_{a, b}, to measure the flow rate of fluid along the respective dispensing line 11_{a, b}. Each flow sensor is operatively connected to the control unit U.

In the embodiment under consideration the flow rate sensors 13_{a, b} are flowmeters. However, several flow sensors can also be installed.

The control unit U is operatively connected to said one or more adjusting valves 12_{a, b} and to said one or more flow rate sensors 13_{a, b}.

In particular, the control unit U receives from the flow rate sensors 13_{a, b} values relating to the flow rate of the fluid measured on the respective dispensing line 11_{a, b}.

With reference to FIG. 6, it is possible to observe a calibration graph of the system 1, relating to the first 11ₐ and second 11_{b} dispensing lines. The values detected by the flow rate sensors 13_{a, b}, measured as the number of pulses per second generally by an encoder, are shown on the abscissa; the ordinates, on the other hand, show the corresponding flow rate values, measured in milliliters per second.

During an initial calibration step, the values detected by the flow rate sensors 13_{a, b} and the respective actual flow values are acquired. Said values are reported in said calibration graph in the form of Cartesian coordinate points.

For each dispensing line 11_{a, b} a linear fit is performed on the obtained points, with which conversion parameters are obtained, i.e., slope and intercept of the straight line, which best approximates the trend of the points on the calibration graph. During the operation of the machine, said conversion parameters are used by the control unit U, to trace the flow rate of fluid delivered starting from the number of pulses detected by the flow rate sensors 13_{a, b}, and can be modified during execution of the calibration method, as better described below. Alternatively, it is also possible for the control unit U to determine the quantity of fluid delivered by measuring the delivery time, using a predetermined fluid delivery rate value, and estimating that it remains constant over time.

Furthermore, the control unit U controls, by means of suitable signals, said adjusting valves 12_{a, b} to regulate the flow rate and therefore the quantity of fluid delivered on each dispensing line 11_{a, b}.

Said calibration unit 16 is operatively connected to said control unit U and measures a value associated with the quantity of fluid delivered by said nozzle 15 into said container B. The calibration unit 16 can be connected to the control unit by connection via cable or wireless, such as Bluetooth®.

The plant 1 can also comprise a gateway G and a cloud unit C.

The gateway G is operationally connected to said control unit U and to said cloud unit C.

The cloud unit C can be connected to mobile devices such as smartphones, tablets and computer, so as to be able to control and start the calibration of said system 1 also remotely or for the collection of data in general relating to the delivery of fluids through the dispensing lines 11_{a, b}. Referring again to FIG. 1, in said first embodiment, said calibration unit 16 comprises an optical sensor 161, arranged in proximity to said nozzle 15 and facing downwards, operatively connected to said control unit U.

The optical sensor 161 is the same already used by the system 1 to determine the optimal filling of the container B.

The optical sensor 161 detects the quantity of fluid dispensed by the nozzle 15 and contained in the container B below, such as for example a cup, and sends the values detected at the control unit U. In particular, the optical sensor 161 detects the height of the cup and the filling level of the cup itself, and it is able to send the detected values to the control unit U, to determine when to stop dispensing the fluid or mixture of fluids.

The control unit U also stores values of dispensing quantity and confidence intervals, or predefined thresholds, associated respectively with each dispensing line 11_{a, b}, also determined on the basis of the type of beverage to be dispensed through each dispensing line 11_{a, b}.

The operation of the system 1 for dispensing one or more fluids, in the first embodiment described above, is as follows.

When it is intended to carry out the calibration of the detection of the flow rate sensors 13_{a, b} of said system 1, a predetermined quantity of fluid is delivered from the first dispensing line 11ₐ into the container B below said nozzle 15.

The delivery time is determined by the control unit U on the basis of said conversion parameters obtained from the linear fit.

It is also possible to start the calibration procedure through a mobile device, remotely connected to said cloud unit C. In particular, the cloud unit C communicates with said control unit U via said gateway G to start the calibration procedure.

Once the dispensing is complete, said optical sensor 161 detects the filling level of container B and sends a signal to said control unit U.

Once the container B volume is known, the control unit U converts the value received from said sensor optical 161 in a fluid volume value. The control unit U then compares the volume value obtained with the predetermined quantity of fluid to be dispensed. If the obtained value deviates from the predetermined value beyond a predefined confidence interval, or beyond a calibration threshold, the control unit U modifies the stored conversion parameters, to make them correspond to what is received by the calibration unit 16. If the obtained value deviates further from the predetermined value, beyond a predefined control interval or beyond a predefined control threshold, the control unit U generates an alarm signal.

If, on the other hand, the received value falls within the confidence interval, the calibration of the dispensing line 11ₐ ends. The same calibration is repeated for the second dispensing line 11_{b} and for every other present delivery line.

It is also possible to perform a calibration for a mixture of several fluids. In this case, two or more fluids are delivered simultaneously in predetermined concentrations into the container B under the nozzle 15 according to the recipe of the desired drink; the optical sensor 161 then carries out the same detection and sends a signal to the control unit U, which carries out the conversions and the consequent adjustments.

Referring now to FIG. 2, it is possible to observe the system 1 for dispensing one or more fluids, in a second embodiment.

In this case, said calibration unit 16 comprises a weight sensor 162, operatively connected to said control unit U, and arranged below said nozzle 15, to be able to receive said container B, such as for example a cup, and measure its mass.

Said weight sensor 162 can be a scale or load cell.

The operation of said plant 1 in the second embodiment described above is, in general terms, similar to that of the plant 1 shown in FIG. 1.

However, in the embodiment at issue, when the control unit U delivers the predetermined quantity of fluid from the dispensing line 11ₐ, the weight sensor 162 detects the mass of fluid delivered by the nozzle 15 and contained in the underlying container B, obviously taking into account the weight of the container B.

Said weight sensor 162 then sends the value detected at the control unit U.

Having known the density of the fluid dispensed, the control unit U converts the value received from said weight sensor 162 into a fluid volume value. The control unit U then compares the volume value obtained with the predetermined quantity of fluid to be dispensed. If the value obtained differs from the predetermined value beyond a confidence interval, the control unit U modifies the stored conversion parameters, to make them correspond to what is received from the calibration unit 16. If, on the other hand, the received value falls within the confidence interval, the calibration of the dispensing line 11ₐ ends.

The same calibration is repeated for the second dispensing line 11_{b} and for every other present delivery line.

It is also possible to perform a calibration for a mixture of several fluids. In this case, two or more fluids are simultaneously delivered in predetermined concentrations into the container B below the nozzle 15; the weight sensor 162 then performs the same detection and sends a signal to the control unit U, which carries out the appropriate conversions and consequent adjustments.

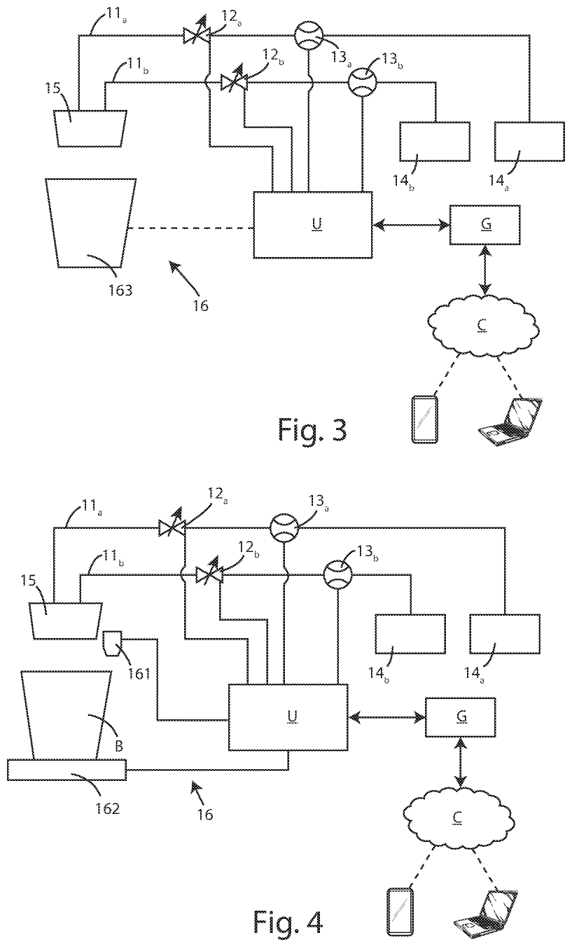

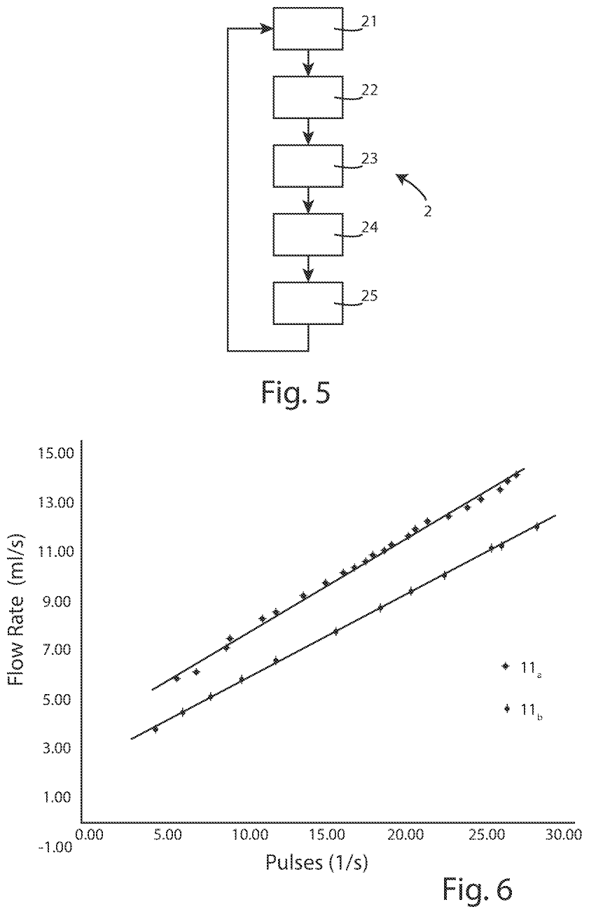

Referring now to FIG. 3, it is possible to observe the system 1 for dispensing one or more fluids, in a third embodiment.

In this case, said calibration unit 16 is a detection container 163, operatively connected to said control unit U, and arranged below said nozzle 15, to receive one or more fluids delivered by the nozzle 15 itself.

Said detection container 163 comprises a plurality of optical sensors, arranged vertically along its internal surface to detect the filling level of the detection container 163 itself. Having known the capacity and the filling level of the detection container 163, the quantity of fluid delivered by said nozzle 15 is possible to trace.

Alternatively, said detection container 163 comprises a weight sensor, such as for example a load cell, arranged at the bottom of the detection container 163, to measure the mass of fluid delivered from said nozzle 15.

Alternatively, the detection container 163 comprises a turbine flow meter, or an ultrasonic flow meter.

The detection container 163 may also comprise two internal partitions, to contain two distinct fluids. In this case, each partition can comprise a plurality of optical sensors and/or a weight sensor, as previously described, so as to perform the calibration of two dispensing lines 12_{a, b} without having to empty the detection container 163.

The detection container 163 can be connected to said control unit U via cables or via wireless communication, such as for example Bluetooth®.

The operation of said system 1 in the third embodiment described above is, in general terms, similar to that of the system 1 shown in FIG. 1.

However, when the control unit U delivers the predetermined quantity of fluid from the dispensing line 11ₐ, the detection container 163 detects its own filling level by means of said optical sensors; alternatively, in the case said detection container 163 comprises a weight sensor, the detection container 163 detects the mass value of fluid delivered by the nozzle 15 and contained in the container B below.

Said weight sensor 162 then sends the detected value to the control unit U.

Having known the density of the fluid dispensed and the capacity of the detection container 163, the control unit U converts the value received from said weight sensor 162 into a fluid volume value. The control unit U then compares the volume value obtained with the predetermined quantity of fluid to be dispensed. If the obtained value differs from the predetermined value beyond a confidence interval, the control unit U modifies the stored conversion parameters, so as to make them correspond to what is received from the calibration unit 16. If, on the other hand, the received value falls within the confidence interval, the calibration of the dispensing line 11ₐ ends.

The same calibration procedure is repeated for the second dispensing line 11_{b} and for every other present delivery line.

If the detection container 163 comprises two internal partitions, it is also possible to simultaneously perform calibration for two dispensing lines 11_{a, b}. In this case, two fluids are delivered in predetermined concentrations into the two partitions of said detection container 163; the ground sensors and/or the plurality of optical sensors present then perform the same detection and send a signal to the control unit U, which carries out the appropriate conversions and consequent adjustments.

Referring now to FIG. 4, it is possible to observe the system 1 for dispensing one or more fluids, in a fourth embodiment.

In this case, said calibration unit 16 comprises an optical sensor 161, as described in the first embodiment, and a weight sensor 162, as described in the second embodiment.

The operation of said system 1 in the fourth embodiment described above is, in general terms, similar to that of the system 1 shown in FIG. 1.

However, said control unit U receives signals both from the optical sensor 161 and from the weight 162. The control unit U therefore compares both signals with predetermined confidence intervals.

If one or both of the values received deviate from the predetermined values beyond a confidence interval, the control unit U modifies the stored conversion parameters, so as to make them correspond to what was received by the calibration unit 16. If, on the other hand, the values received fall within the confidence interval, the calibration of the dispensing line 11ₐ ends.

The same calibration is repeated for the second dispensing line 11_{b} and for every other present delivery line.

It is also possible to perform a calibration for a mixture of several fluids. In this case, two or more fluids are delivered simultaneously in predetermined concentrations into the container B below the nozzle 15; the optical sensor 161 and the weight sensor 162 then perform the same readings and send signals to the control unit U, which carries out the appropriate adjustments.

### Advantages

A first advantage of the present invention is the possibility of having a dispensing system whose calibration is automated.

A further advantage of the present invention is the possibility of having a dispensing system whose calibration is rapid.

The present invention has been described for illustrative but not imitative purposes, according to its preferred embodiments, but it is to be understood that modifications and/or changes can be introduced by those skilled in the art without departing from the relevant scope as defined in the enclosed claims.

1. A plant for dispensing a beverage having one or more fluids ingredients into a container, the plant comprising
one or more dispensing lines to dispense said one or more fluid ingredients,
a nozzle fluid-dynamically connected to said one or more dispensing lines for dispensing said beverage into said container,
a control unit configured to associate values with the flow rate of fluid in said one or more dispensing lines,
said plant further comprising:
at least one calibration unit operatively connected to said control unit for measuring a value associated with the quantity of fluids dispensed into said container, and
said control unit is configured to adjust the values associated with the flow rate of the fluid in each of said one or more dispensing lines so that the difference between the measurement of said values associated with the quantity of fluids delivered in said container and the quantity of fluid associated with said flow rate of fluid in said one or more dispensing lines is less than a predefined calibration threshold or in a predefined calibration confidence interval.

2. The plant according to claim 1, wherein
one or more predetermined flow rate values are stored in said control unit, each associated with a line of said one or more dispensing lines, and
said control unit is configured to estimate the quantity of fluid delivered starting from the delivery time and from said one or more predetermined flow rate values.

3. The plant according to claim 1,
further comprising one or more flow rate sensors, wherein each flow rate sensor is arranged on a respective dispensing line, to measure the flow rate of delivered fluid,
said control unit is connected to said flow rate sensors_and is configured to:
receive the measurement of the flow rate detected by each flow rate sensor, and
adjust the value associated with the detection of each of said flow rate sensors so that the difference between the measurement of said value associated with the quantity of fluids delivered in said container and the detection of the quantity of fluid dispensed through one or more dispensing lines associated with the respective flow rate sensors is less than said predefined calibration threshold or in a predefined calibration confidence interval.

4. The plant according to claim 3,
further comprising one or more adjusting valves, each arranged on a respective dispensing line in series with a respective flow rate sensor for adjusting the quantity of fluid ingredient dispensed through said respective dispensing line and
said control unit is connected to said adjusting valves and configured to control each of said adjusting valves.

5. The plant according to claim 1, wherein said calibration unit comprises an optical sensor arranged in proximity to said nozzle and operatively connected to said control unit, the optical sensor configured for detecting the filling level of said container.

6. The plant according to claim 1, wherein said calibration unit comprises a weight sensor arranged below said nozzle and operatively connected to said control unit, of the calibration unit configured for detecting the mass of said container.

7. The plant according to claim 1,
wherein said calibration unit comprises a detection container operatively connected to said control unit and configured to be arranged below said nozzle when the calibration is required, and
said detection container comprises two internal partitions, each designed to contain one or more fluids delivered from said nozzle.

8. The plant according to claim 1, further comprising one or more tanks in fluid dynamic communication with said one or more dispensing lines in which one or more fluids to be dispensed contained.

9. The plant according to claim 1, further comprising:
a gateway connected to said control unit, and
a cloud unit connected to said gateway and connectable to mobile devices to control and start the calibration of said plant, wherein the calibrations of said plant are stored in said cloud unit.

10. A calibration method of a plant according to claim 1, wherein conversion parameters are stored in said control unit to associate said values to the fluid flow rate, the calibration method comprising the following steps:
activating the delivery of a fluid from a first dispensing line into said container through said nozzle;
receiving a value associated with the quantity of fluid delivered into said container;
converting said value received into a quantity value of said fluid by means of said conversion parameters;
comparing said value converted with a confidence interval or with a predefined threshold, such that
if said value lies outside said confidence interval or it is greater than said predefined threshold, adjusting said parameters for converting said received value into a quantity value of said fluid;
or, if said value lies within said confidence interval or it is greater than said predefined threshold, terminating the calibration of said first dispensing line;
repeating the previous steps for said second dispensing line and for each of said dispensing lines.

11. The calibration method according to claim 10, wherein in said comparison step, if one of said converted values lies outside a control interval, greater than said confidence interval of calibration, or is greater than a predefined control threshold greater than said calibration threshold, an alarm is generated.

12. A computer program comprising instructions which, when the program is executed by a computer, causes the computer to execute the steps of said method according to claim 10.

13. A storage medium readable by a computer comprising instructions which, when executed by a computer, causes the computer to execute the steps of said method according to claim 10.
